(19) United States
(12) Patent Application Publication
(10) Pub. No.: US 2009/0320662 A1
(43) Pub. Date: Dec. 31, 2009

(54) CUTTING METHOD FOR PLANOGRAHIC PRINTING PLATES

(75) Inventor: Yasuhiro Annoura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/294,932

(22) PCT Filed: Mar. 29, 2007
(86) PCT No.: PCT/JP2007/057622

§ 371 Date: Jan. 26, 2009

(30) Foreign Application Priority Data
Mar. 31, 2006 (JP) 2006-100462

(51) Int. Cl. B26D 3/00; B26D 1/06

(52) U.S. Cl. 83/56

(57) ABSTRACT

The present invention provide a planographic printing plate (2) cutting method for cutting a sheaf (1) of a plurality of planographic printing plates (2) by pressing down a cutting blade (12), wherein a moving speed of an edge of the cutting blade (12) moving across the sheaf (1) of the planographic printing plates (2) is equal to or not less than 205 mm/s but equal to or not more than 260 mm/s. Therefore, the sticking of aluminum to the edge of the cutting blade (12) is prevented and thereby preventing from damaging the cut faces of the planographic printing plate (2), even if the large number of the planographic printing plate (2) are cut.

### TECHNICAL FIELD

The present invention relates to a cutting method for planographic printing plates, and more particularly to a cutting method for planographic printing plates by which a stacked sheaf of planographic printing plates is cut by pressing down a cutting blade.

### BACKGROUND ART

Planographic printing plates are diverse in size, and in some cases sheaves of stacked sheets cut out of coils are trimmed to the final product size at the trimming stage. Since a plurality of plates are cut at the same time at the trimming stage, there may occur peculiar defects.

For instance, since a printing image is directly written onto the image formation face of a laser-exposed type planographic printing plate with a laser beam emitted from a laser beam source, a slight deviation in distance from the laser beam source may invite an evident variation in sensitivity, and therefore the floating of a laser-exposed type planographic printing plate during exposure requires strict control.

The bulging part in the thickness direction, the so-called “return”, which arises on the cut edges of the planographic printing plate when it is cut, is one of the causes of the floating, and its permissible limit is supposed to be 200 μm or less for planographic printing plates of the usual level of sensitivity, for instance. For laser-exposed type planographic printing plates, the limit is even 50 μm or less because of the aforementioned need to control the floating with particular strictness.

### DISCLOSURE OF THE INVENTION

In order to reduce the return, it is generally considered appropriate to finish the edge of the cutting blade sharp so that its shape can be maintained even after many planographic printing plates have been cut. And this purpose is considered achievable by using a very hard material for the edge. From this point of view, Japanese Patent Application Laid-Open No. 11-300688 proposes a cutting blade consisting of an edge metal formed from powder die steel and brazed onto a notched step portion provided on a pedestal.

However, as a harder material usually invites a decrease in tenacity and accordingly brittleness, use of a very hard material for the edge of the cutting blade or increasing the surface hardness of the edge would result in a disadvantage of making the edge vulnerable to cracking.

Also, whereas a very hard material often has a high chromium content, chromium is susceptible to the sticking of the metal extensively used as a support to planographic printing plates, such as aluminum. Therefore, cutting a sheaf of planographic printing plates with a cutting blade having an edge formed of such a hard material involves a disadvantage that the aluminum sticking to the edge might damage the cut faces of the printing plates, which would seriously affect their commercial values.

An object of the present invention, attempted in view of these circumstances, is to provide a cutting method for planographic printing plates which permits cutting a large number of planographic printing plates without damaging their cut faces.

In order to achieve the object stated above, according to a first aspect of the present invention, there is provided A planographic printing plate cutting method for cutting a sheaf of a plurality of planographic printing plates by pressing down a cutting blade, wherein a moving speed of an edge of the cutting blade moving across the sheaf of the planographic printing plates is equal to or not less than 205 mm/s but equal to or not more than 260 mm/s.

According to the first aspect of the invention, the moving speed of the edge of the cutting blade moving across the sheaf of the planographic printing plates is set to be not less than 205 mm/s but not more than 260 mm/s. This enables the sheaf of many planographic printing plates to be cut without allowing the cut faces to be damaged.

In order to achieve the object stated above, according to a second aspect of the present invention, there is provided the planographic printing plate cutting method according to the first aspect, wherein the sheaf of the planographic printing plates is cut by pressing down the edge of the cutting blade while the edge of the cutting blade is swinging.

According to the second aspect of the invention, the sheaf of planographic printing plates is cut by pressing down the edge of the cutting blade while it is swinging.

In order to achieve the object stated above, according to a third aspect of the present invention, there is provided the planographic printing plate cutting method according to the first or second aspect wherein a dose of coating for a coat to constitute the image formation face of the planographic printing plate is set to 1.1 g/m² or more.

According to the third aspect of the invention, the dose of coating for the coat to constitute the image formation faces of the planographic printing plates is set to 1.1 g/m² or more. This enables the sheaf of an even greater number of planographic printing plates to be cut without allowing the cut faces to be damaged.

In order to achieve the object stated above, according to a fourth aspect of the present invention, there is provided the planographic printing plate cutting method according to any one of the first through third aspects, wherein when a sheaf of planographic printing plates having a image formation face stuck to a slip-sheet is cut, the basis weight of the slip-sheets is set to be 40 g/m² or more.

According to the fourth aspect of the invention, when a sheaf of planographic printing plates to whose image formation faces slip-sheets are stuck is to be cut, the basis weight of the slip-sheets is set to be 40 g/m² or more. This enables the sheaf of an even greater number of planographic printing plates to be cut without allowing the cut faces to be damaged.

The cutting method for planographic printing plates according to the invention permits cutting of a large number of planographic printing plates without damaging their cut faces.

### BRIEF DESCRIPTION OF THE DRAWINGS

FIG. 1 shows an external view of an example of cutting apparatus;

FIG. 2 illustrates the operating method of the cutting blade;

FIG. 3 shows a schematic configuration of the driving mechanism for the cutting blade of the cutting apparatus; and

FIG. 4 illustrates the cutting method using the cutting blade.

### DESCRIPTION OF SYMBOLS

1 . . . Planographic printing plate stacked sheaf, 2 . . . planographic printing plate, 3 . . . slip-sheet, 4 . . . protective cardboard, 10 . . . cutting apparatus, 12 . . . cutting blade, 14 . . . surface table, 16 . . . body frame, 18 . . . holder, 28 . . . motor

### BEST MODE FOR CARRYING OUT THE INVENTION

Preferable modes of the method of cutting planographic printing plates according to the present invention will be described blow with reference to the accompanying drawings.

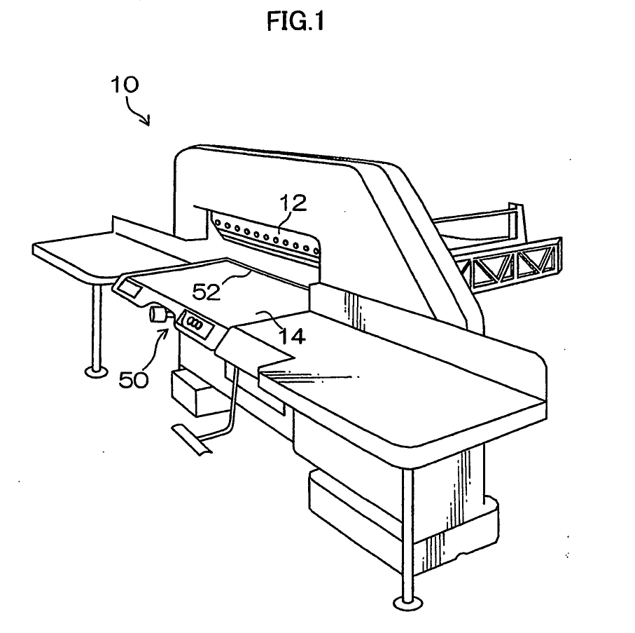

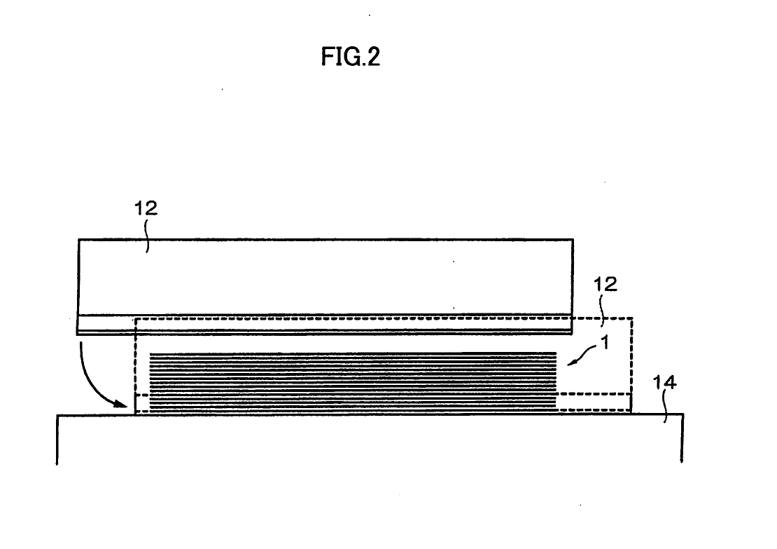

FIG. 1 shows an external view of an example of cutting apparatus for use in the invention. As shown in the drawing, the cutting apparatus 10 is provided with a long cutting blade 12. By pressing down the cutting blade 12 while it is swinging as shown in FIG. 2, a planographic printing plate stacked sheaf 1 set on a surface table 14 is cut.

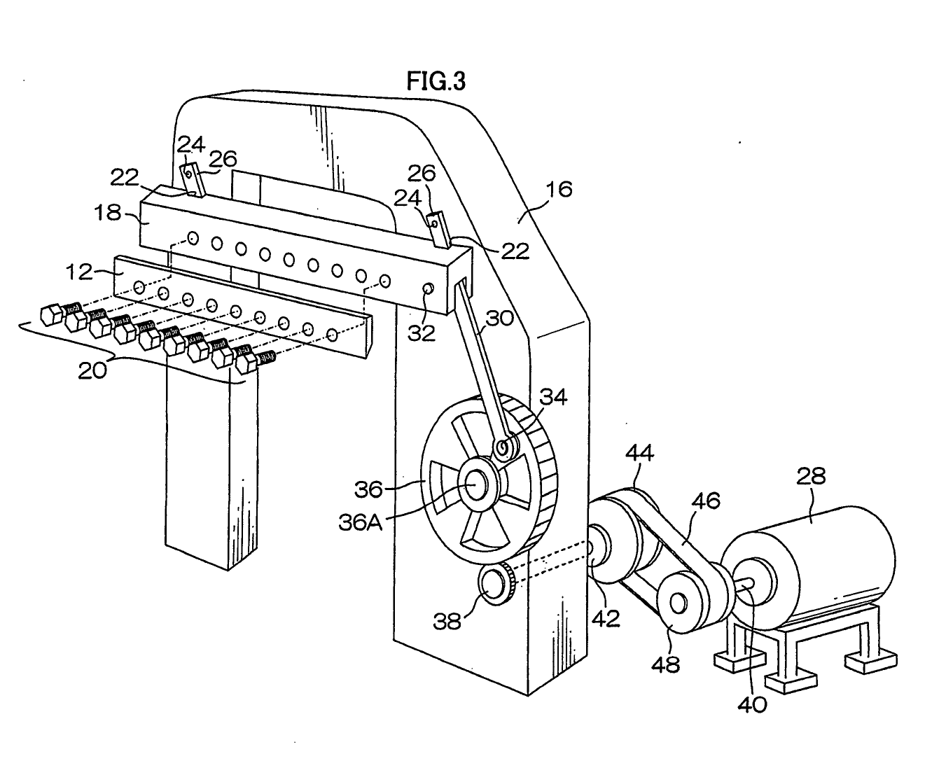

FIG. 3 shows a schematic configuration of the driving mechanism for the cutting blade 12 of the cutting apparatus 10. As shown in the drawing, the cutting blade 12 is fixed to a holder 18 disposed on the body frame 16 of the cutting apparatus 10 by bolts 20, 20 . . . .

The holder 18 is movably disposed on the body frame 16, and a pair of guide grooves 22 for guiding its movement is formed in the rear face. Slide stops 26, swingably supported by the body frame 16 via supporting pins 24, are swingably supported in the pair of guide grooves 2. The holder 18 is so guided by these slide stops 26 and guide grooves 22 to form a prescribed kinetic locus.

The holder 18 operates driven by a motor 28, and one end of a connecting rod 30 for transmitting the motive power of the motor 28 is connected to one end of the holder 18 via a link pin 32. The other end of the connecting rod 30 is linked to a crank gear 36 via a linking pin 34, and the linking pin 34 is fitted eccentrically relative to the rotation shaft 36A of the crank gear 36.

The rotation shaft 36A of the crank gear 36 is rotatably supported by a bearing (not shown) disposed on the body frame 16. A fly-wheel 44 is linked to the crank gear 36 via a gear 38, and a clutch brake 42 is fitted to the fly-wheel 44.

On the other hand, a drive pulley 48 is fitted to the output shaft 40 of the motor 28, and a drive belt 46 is wound between the drive pulley 48 and the fly-wheel 44. The arrangement enables the rotation of the motor 28 to be transmitted from the drive pulley 48 via the drive belt 46 to turn the fly-wheel 44.

When a blade lowering switch is turned on, the clutch brake 42 is changed over from braking to clutching, and the crank gear 36 is turned via the gear 38. The rotation of the crank gear 36 is transmitted to the holder 18 via the connecting rod 30, and the holder 18 operates following a prescribed kinetic locus. Thus, the cutting blade 12 fitted to the holder 18 operates to be pressed down while it is swinging.

Incidentally, engagement of the gear 38 linked to the clutch brake 42 with the crank gear 36 prevents other parts including the equipment main body from being subjected to loads beyond certain limits.

Further, the motor 28 is equipped with an inverter (not shown), and the moving speed of the cutting blade 12 can be regulated by controlling the frequency of power supplied to the motor 28 with the inverter. The control of the inverter is performed by a controller (not shown), and the controller so controls the inverter to provide a frequency set on the basis of an input from the operating unit 50 (see FIG. 1) of the cutting apparatus 10.

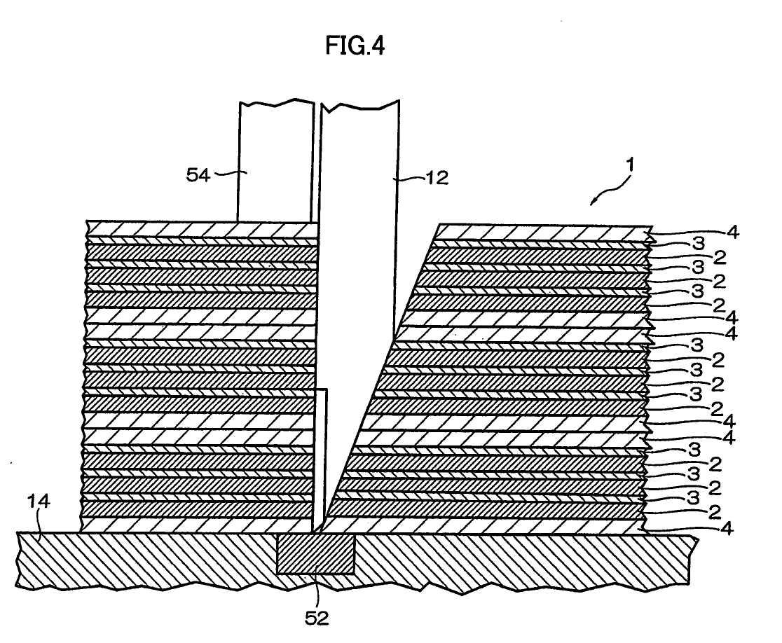

Further, as shown in FIG. 1 and FIG. 4, the surface table 14 is provided with a wooden pad 52, and the wooden pad 52 is so disposed as to receive the edge of the cutting blade 12.

A clamp 54 is so arranged above the surface table 14 as to leave a gap of 0 to 5 mm parallel to the cutting blade 12, and the planographic printing plate stacked sheaf 1 set on the surface table 14 is held down by the clamp 54 as shown in FIG. 4 when the planographic printing plate stacked sheaf 1 is cut.

Incidentally, as the cutting blade 12, the cutting blade described in Japanese Patent Application Laid-Open No. 2001-18190, for instance, is used and formed in a size of 2190 mm in length, 149 mm in height and 12 mm in thickness for example.

The cutting apparatus 10 is configured as described above.

Next, a method for cutting planographic printing plates by using the cutting apparatus 10 according to the invention will be described.

As stated above, the cutting blade 12 operates driven by the motor 28 and, by descending while it is swinging as shown in FIG. 2, cuts the planographic printing plate stacked sheaf 1 set on the surface table 14.

Usually, the frequency of the power supplied to the motor 28 which drives the cutting blade 12 is set to 60 Hz. Then, the edge of the cutting blade 12 moves across the planographic printing plate sheaf 1 at a speed of about 350 mm/s.

However, if a sheaf of many planographic printing plates supported by aluminum is cut under the condition, the aluminum will stick to the cutting blade 12, giving rise to damage to the cut faces, though there will be no problem if the number of plates constituting the sheaf is small.

The moving speed of the cutting blade 12 is reduced according to the planographic printing plate cutting method in the mode for implementing the invention in view of the problem, and it is thereby made possible to cut many planographic printing plates without allowing aluminum to stick to the edge of the cutting blade 12.

More specifically, the frequency of power supplied to the motor 28 is set to 45 Hz or less by the inverter, and the edge of the cutting blade 12 is so set as to move at a speed of no more than about 260 mm/s relative to the planographic printing plate sheaf 1 (about 75% or less of the usual moving speed) to enable a large number of (e.g. 100) planographic printing plates to be cut.

It has to be noted that setting the moving speed of the edge of the cutting blade 12 too low would reduce the machining power and cause the cutting blade 12 to stop on the way. The moving speed of the edge of the cutting blade 12 should be set within the limit of not inviting such a problem.

More specifically, the frequency of power supplied to the motor 28 should be set by the inverter to 35 Hz or more and to 45 Hz or less to cause the edge of the cutting blade 12 to move at a speed of not less than about 205 mm/s but not more than about 260 mm/s (about 58% to 75% of the usual moving speed) relative to the sheaf of planographic printing plates.

By regulating the moving speed of the edge of the cutting blade 12 in this way, even if a large number of planographic printing plates supported by aluminum are cut, the aluminum can be prevented from sticking to the edge of the cutting blade 12 and the plates can be cut without suffering damage to their cut faces.

More specifically as shown in FIG. 4, even if a sheaf 1 (which has protective cardboards 4 arranged on the top and bottom faces thereof) of 100 planographic printing plates 2 (0.3 mm in thickness) using aluminum as the support and having slip-sheets 3 (plain paper of 40 g/m² in basis weight) stuck to their image formation faces (faces on which coat layers (such as photosensitive layers or thermosensitive layers) are formed) is cut, the aluminum can be prevented from sticking to the edge and the plates can be cut without suffering damage to their cut faces.

To add, the sticking of aluminum can also be prevented by varying the basis weight (the thickness) of the slip-sheet that is used. Where plain paper is used as slip-sheets, the sticking of aluminum to the edge can be effectively prevented by varying its basis weight (increasing its thickness).

More specifically, where planographic printing plates of 0.3 mm in thickness are to be cut, the use of slip-sheets which consist of plain paper of 40 g/m² in basis weight would enable the number of cutting actions until aluminum starts to stick to the edge of the cutting blade 12 to be increased even if 150 plates are stacked.

The sticking of aluminum also varies with the dose of coating applied to form the image formation faces (namely the thicknesses of coats) of the planographic printing plates. Slip-sheets of the same basis weight being used, the sticking of aluminum to the edge can be effectively prevented by keeping the dose of coating applied at no less than 1.1 g/m².

Further if polyethylene-laminated plain paper is used instead of plain paper as slip-sheets, the sticking of aluminum to the edge can be effectively prevented even if the planographic printing plates are only thinly coated.

As described so far, by setting the frequency of power supplied to the motor 28 to not less than 35 Hz but not more than 45 Hz with the inverter and moving the edge of the cutting blade 12 at a speed of not less than about 205 mm/s but not more than about 260 mm/s (about 58% to 75% of the usual moving speed) relative to the sheaf of planographic printing plates while cutting them, aluminum can be prevented from sticking to the edge of the cutting blade 12 even if a large number of planographic printing plates are cut. In this way, a sheaf of even a large number of planographic printing plates can be cut at a time without damaging their cut faces.

When slip-sheets of plain paper are used, choice of such paper measuring 40 g/m² or more in basis weight would make possible even more effective prevention of the sticking of aluminum and cutting of a greater number of plates.

The basis weight of slip-sheet being the same, by keeping the dose of coating applied as the coat to constitute the image formation faces of the planographic printing plates at no less than 1.1 g/m², the sticking of aluminum to the edge can be effectively prevented.

Incidentally, though the embodiment described above supposes the application of the invention to a cutting apparatus in which the cutting blade 12 is driven by the motor 28, the application of the invention is not limited to the described configuration. For instance, it can be similarly applied to a cutting apparatus in which the cutting blade is driven by a hydraulic mechanism. In this case, too, the sheaf of planographic printing plates are cut with the edge of the cutting blade being controlled to move at a speed of not less than about 205 mm/s but not more than about 260 mm/s relative to the sheaf.

The foregoing description referred to the application of the invention to a cutting apparatus in which the cutting blade 12 cuts a sheaf of planographic printing plates while being pressed down while it is swinging, the application of the invention is not limited to the described configuration. For instance, it can be similarly applied to a cutting apparatus in which the cutting blade is pressed down perpendicularly to cut a sheaf of planographic printing plates. In this case as well, the sheaf of planographic printing plates are cut with the edge of the cutting blade being controlled to move at a speed of not less than about 205 mm/s but not more than about 260 mm/s relative to the sheaf.

The moving speed of the edge of the cutting blade 12 is controlled by the inverter of the motor 28, the device of controlling the moving speed of the edge of the cutting blade 12 is not limited to this. Any other appropriate known transmission mechanism can be used to regulate the transmission of rotation force from the motor 28 thereby to control the edge of the cutting blade 12.

To add, by regulating the frequency of power supplied to the motor 28 with the inverter to control the moving speed of the edge of the cutting blade 12 as in the cutting apparatus in the above-described embodiment, the hardware configuration can be simplified, and so can be its control. It also enables the invention to be easily implemented with any known appropriate cutting apparatus.

The material of the cutting blade 12 to be used may be any appropriate high hardness steel for use in cutting edge, such as high speed steel, powder metallurgy high speed steel or tungsten carbide.

### EXAMPLE

To confirm the effectiveness of the cutting method for planographic printing plates according to the invention, the following tests were carried out.

First to confirm the effect to prevent aluminum from sticking to the edge of the cutting blade, a sheaf of planographic printing plates was cut at different moving speeds of the edge of the cutting blade and the extent of sticking of aluminum to the edge was checked.

Planographic printing plates “CTP HP-S” manufactured by Fujifilm Corporation, measuring 1140 mm in length, 700 mm in width and 0.3 mm in thickness were used for the test cutting, and plain paper of 40 g/m² was used as slip-sheets to be stuck to the image formation faces.

A sheaf of 100 such planographic printing plates was formed, and cut into two sheaves of planographic printing plates measuring 650 mm in length and 550 mm in width.

As the cutting apparatus, a cutting machine “eRC-137” manufactured by Itotec Co., Ltd. was used. The motor, serving as the driving mechanism for the cutting blade, was equipped with an inverter, with which the frequency of power supplied to the motor was varied to make the moving speed of the edge of the cutting blade variable.

In the cutting apparatus, when the frequency of power supplied to the motor is set to 60 Hz (usual frequency) and the cutting blade is swinging to cut a sheaf of planographic printing plates, the cutting blade moves at a speed of about 350 mm/s. The moving speed was measured in the following manner.

Thus, when the prescribed objects were cut with the apparatus and their cut faces were checked, scars inclined at about 45 degrees were found. It can be presumed that the cutting blade moves with an inclination of about 45 degrees relative to the objects of cutting by the above described result.

The length of time the cutting blade took to reach the end of descent from the peak of ascent was also measured, and it was 0.8 sec.

The cutting blade was fitted with spaces of 198 mm at the left end and 170 mm at the right end. Supposing that the blade moves with a relative inclination of about 45 degrees with reference to the space height at the left end (198 mm), its moving speed S relative to the objects of cutting should be S=(198 mm/0.8 sec)×1.414≦350 mm/s.

As a result, the moving speed of the edge of the cutting blade is about 321 mm/s when the frequency of power supplied to the motor is 55 Hz, about 292 mm/s when the power frequency is 50 Hz, about 263 mm/s when the power frequency is 45 Hz, about 233 mm/s when the power frequency is 40 Hz and about 204 mm/s when the power frequency is 35 Hz.

With the cutting apparatus of such a configuration, the sheaf of planographic printing plates was cut with the frequency of power supplied to the motor being varied from 60 Hz to 55 Hz, 50 Hz, 45 Hz, 42 Hz, 40 Hz and 35 Hz, and the extent of aluminum sticking to the edge of the cutting blade was checked. The results are tabulated in table 1 below.

In the table, the evaluation of “Poor” means that grain-like aluminum particles were clearly observed on the edge of the cutting blade by visual observation and a scar was formed on the cut face.

TABLE 1

| Frequency | 60 Hz | 55 Hz | 50 Hz | 45 Hz | 42 Hz | 40 Hz | 35 Hz |
|---|---|---|---|---|---|---|---|
| Moving speed of | 350 mm/s | 321 mm/s | 291 mm/s | 263 mm/s | 245 mm/s | 233 mm/s | 204 mm/s |
| edge | | | | | | | |
| Aluminum sticking to | Poor | Poor | Poor | Poor | Good | Good | Good |
| the edge of the | | | | | | | |
| cutting blade | | | | | | | |

As is evident from these test results, where the frequency of power supplied to the motor was from 60 Hz to 50 Hz, namely in the range of the relative moving speed of the edge of the cutting blade 12 from about 350 mm/s to about 292 mm/s, the sticking of aluminum to the edge of the cutting blade was visible. However, it was confirmed that, where the frequency of power supplied to the motor was from 35 Hz to 45 Hz, namely in the range of the relative moving speed of the edge of the cutting blade from about 204 mm/s to about 263 mm/s (in the range of about 58% to 75% of the usual speed), the sticking of aluminum to the edge was successfully prevented.

Further to check the influence of the basis weight of the slip-sheets (plain paper) used, 150 plates were cut where the frequency of power supplied to the motor was from 35 Hz to 45 Hz, namely in the range of the relative moving speed of the edge of the cutting blade from about 204 mm/s to about 263 mm/s. While aluminum began to stick to the edge in the 25th round of the cutting of 150 plates when the basis weight was 40 g/m², no aluminum was found sticking to the edge even in the 50th round when the basis weight was 50 g/m². Thus, it became certain that an increase in the basis weight of the slip-sheets used could further enhance the effectiveness of prevention of aluminum sticking.

Then, to assess the influence of the dose of coating to constitute the image formation faces (the thickness of coat) and the basis weight of slip-sheets (the thickness of slip-sheets) on the edge of the cutting blade, the following test was carried out.

Thus, sheaves were formed of planographic printing plates differing in the dose of coating for the coat and slip-sheets differing in basis weight and cut under the same conditions, and the extents of aluminum sticking to the edge were checked.

As the planographic printing plates, various products including conventional planographic printing plates CTP (thermal type and photopolymer type) measuring 400 mm in length, 600 mm in width and 0.3 m in thickness, manufactured by Fujifilm Corporation were used, and as the slip-sheets, slip-sheets of plain paper of 30 g/m² in basis weight (slip-sheets A), slip-sheets of plain paper of 40 g/m² in basis weight (slip-sheets B), slip-sheets of plain paper of 50 g/m² in basis weight (slip-sheets C) and slip-sheets consisting of plain paper of 30 g/m² in basis weight covered with a polyethylene laminate of 10 μm (slip-sheets D) were used.

Different combinations of these planographic printing plates and slip-sheets were put together into three sheaves of 50 plate-sheets each (altogether 150), and protective cardboards of 750 g/m² in basis weight were arranged on the top and bottom faces of each plate-sheet. They were cut into sheaves of 400 mm in length and 300 mm in width, and the extents of aluminum sticking to the edge were checked.

Incidentally, a cutting machine “eRC-137” manufactured by Itotec Co., Ltd. was used as the cutting apparatus, and the cutting was done in accordance with the standard conditions for the equipment.

The results are tabulated in Table 2 below.

In the table, the evaluation of “Poor” means that grain-like aluminum particles were clearly observed on the edge of the cutting blade by visual observation and a scar was formed on the cut face; “Good” means that no problem occurred in 30 trials; and “Fair” means that a scar was formed on the cut face midway in the process.

TABLE 2

| | | Slip-sheets | | | |
|---|---|---|---|---|---|
| | | (basis weight) | | | |
| | | | | | Slip-sheet D |
| | | Slip-sheet A | Slip-sheet B | Slip-sheet C | (Slip-sheet A + |
| | | (30 g/m²) | (40 g/m²) | (50 g/m²) | PE 10 μm) |
| Products | Product A (0.5 g/m²) | Poor | Poor | | Good |
| (dose) | Product B (1.0 g/m²) | | Poor | | |
| | Product C (1.1 g/m²) | Poor | Fair | Good | |
| | Product D (1.2 g/m²) | Poor | Fair | Good | |
| | Product E (1.4 g/m²) | | Good | | |
| | Product F (1.8 g/m²) | Good | | | |
| | Product G (2.8 g/m²) | | Good | | |
| | Product H (3.8 g/m²) | | Good | | |

The results of the test, too, revealed that, the cutting conditions being the same, the greater the basis weight of (the thicker) the slip-sheets used, or the greater the dose of coating for (the thicker) the coat, the greater the effect to prevent aluminum sticking to the edge.

Regarding slip-sheets in particular, where plain paper was used, 40 g/m² or more in basis weight and 1.1 g/m² or more in the dose of coating for the coat were confirmed to ensure effective prevention of aluminum sticking to the edge.

Further, the use of slip-sheets covered with a polyethylene laminate of 10 μm (slip-sheets D) was found significantly effective. The particular effectiveness of polyethylene-laminated slip-sheets to prevent aluminum sticking suggests that the dose threshold of effectiveness varies with the coating material used. For instance, it is known that polymer content is more effective than the usual monomer content, the choice of one or another belonging to the realm of design considerations.

1. A planographic printing plate cutting method for cutting a sheaf of a plurality of planographic printing plates by pressing down a cutting blade, wherein
a moving speed of an edge of the cutting blade moving across the sheaf of the planographic printing plates is equal to or not less than 205 mm/s but equal to or not more than 260 mm/s.

2. The planographic printing plate cutting method according to claim 1, wherein
the sheaf of the planographic printing plates is cut by pressing down the edge of the cutting blade while the edge of the cutting blade is swinging.

3. The planographic printing plate cutting method according to claim 1, wherein
a dose of coating for a coat to constitute the image formation face of the planographic printing plate is set to 1.1 g/m² or more.

4. The planographic printing plate cutting method according to claim 1, wherein
when a sheaf of planographic printing plates having a image formation face stuck to a slip-sheet is cut, the basis weight of the slip-sheets is set to be 40 g/m² or more.

5. The planographic printing plate cutting method according to claim 2, wherein
a dose of coating for a coat to constitute the image formation face of the planographic printing plate is set to 1.1 g/m² or more.

6. The planographic printing plate cutting method according to claim 2, wherein
when a sheaf of planographic printing plates having a image formation face stuck to a slip-sheet is cut, the basis weight of the slip-sheets is set to be 40 g/m² or more.

7. The planographic printing plate cutting method according to claim 3, wherein
when a sheaf of planographic printing plates having a image formation face stuck to a slip-sheet is cut, the basis weight of the slip-sheets is set to be 40 g/m² or more.

8. The planographic printing plate cutting method according to claim 5, wherein
when a sheaf of planographic printing plates having a image formation face stuck to a slip-sheet is cut, the basis weight of the slip-sheets is set to be 40 g/m² or more.
